(19) United States
(12) Patent Application Publication
(10) Pub. No.: US 2003/0162158 A1
(43) Pub. Date: Aug. 28, 2003

(54) Manipulative teaching aid

(76) Inventor: Maryellen Rooney Moreau, (US)

Correspondence Address: DOHERTY, WALLACE,, PILLSBURY AND MURPHY, P.C., ONE MONARCH PLACE, 19TH FLOOR, 1414 MAIN STREET, SPRINGFIELD, MA, 01144-1002, US

(21) Appl. No.: 10/264,717

(22) Filed: Oct. 4, 2002

Related U.S. Application Data
(60) Provisional application No. 60/360,435, filed on Feb. 28, 2002.

(51) Int. Cl. G09B 5/00

(52) U.S. Cl. 434/309

(57) ABSTRACT

The present invention is a manipulative teaching aid designed to develop the discourse level of language development in children. The invention builds narrative or discourse skills, which connect speech with written language. The present invention has a soft, flexible body member from which a plurality of arm and leg members protrudes. Additionally, there are a plurality of indicia that removably attach to the body, leg, and arm members. The arm members serve as a means to attach the invention to the child or teacher. The leg members hold removable indicia that represent action sequences of a story including an initiating event, reactions to the action sequences, internal responses/feelings resulting from the action sequences, and the resolution of the story. The body member holds removable indicia that create the identity of the character in the story and the setting of the story. The teaching aid may be worn, touched and moved by a person.

### CROSS REFERENCE TO RELATED APPLICATIONS

Provisional Application No. 60/360,435

### STATEMENT REGARDING FEDERALLY SPONSORED RESEARCH OR DEVELOPMENT

Not Applicable

### BACKGROUND OF THE INVENTION

This invention relates to a manipulative teaching aid. Specifically, the invention is a three-dimensional plush teaching aid designed to develop the discourse level of language development in children. The invention builds narrative or discourse skills, which connect speech with written language.

It is well known that literacy development and language acquisition are intertwined from a very young age. Language development is enhanced by literacy-related activities such as shared book reading and storytelling. Further, research indicates that oral language skills are predictors of and causal factors in reading achievement. In light of the above, when designing early intervention strategies for preschool aged children at academic risk, there is a growing recognition of the need to target oral language proficiency in the areas of vocabulary and the use of language in extended discourse such as conversation and narrative development. The present invention is aimed at doing just this.

The present invention fosters language development skills in the context of playing, listening, talking, conversing, retelling, drawing, and early written expression.

### BRIEF SUMMARY OF THE INVENTION

It is the object of the present invention to provide a teaching aid which helps children reconstruct and express their personal experiences in their own words.

It is a further object of the present invention to provide a teaching aid that helps children reconstruct storybook content in their own words.

It is a further object of the present invention to provide a teaching aid that is responsive to individual differences in learning.

It is a further object of the present invention to provide a teaching aid that enables a teacher to focus intervention for children with disabilities who are playing and learning together with typically developing peers.

It is a further object of the present invention to provide a teaching aid that helps children retain information by relating components.

It is a further object of the present invention to provide a teaching aid that helps children infer information that is not directly stated.

It is a further object of the present invention to provide a teaching aid that helps children initiate participation at their own pace.

It is a further object of the present invention to provide a teaching aid that helps children to think critically and to prepare themselves for the future.

The present invention consists of a soft flexible body member to which a plurality of arm and leg members is attached. Additionally, there are a plurality of indicia that removably attach to the body, leg, and arm members. The arm members serve as a means to attach the invention to the child or teacher. The leg members hold the removable indicia that represent action sequences of a story including an initiating event, reactions to the action sequences, internal responses/feelings resulting from the action sequences, and the resolution of the story. The body member holds removable indicia that create the identity of the character in the story and the setting of the story. The teaching aid may be worn, touched and moved by a person and is washable.

### BRIEF DESCRIPTION OF THE DRAWINGS

FIG. 1 is a view of the teaching aid unadorned with indicia.

FIG. 2 is a view of the teaching aid configured to resemble a dog with multiple indicia removably attached to the teaching aid.

FIG. 3 is a view of the teaching aid configured to resemble a rabbit.

FIG. 4 is a view of the teaching aid configured to resemble a girl.

FIG. 5 is a view of the teaching aid configured to resemble a boy.

### DETAILED DESCRIPTION OF THE INVENTION

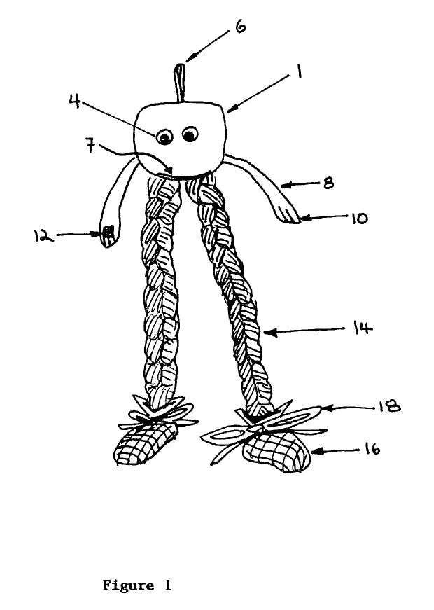

Referring to FIG. 1, the invention is comprised of a soft flexible body member 1. In its preferred configuration, the body member contains eyes 4 and an attachment means 6 such as a loop of fabric. The attachment means allows the teaching aid to be suspended from a hook, doorknob or similar protrusion. While in its preferred configuration the attachment means is a loop of fabric, a wide variety of attachment means may be utilized. In its preferred configuration, the body member is manufactured from a washable, wearable material.

The body member also contains a cavity 7. The cavity allows for the insertion of a user's hand so that the invention may be manipulated in a manner similar to that of a hand puppet. Alternatively, the body member may not contain a cavity.

The body member contains at least one flexible arm member 8. In its preferred configuration, and as depicted in FIG. 1, the invention has two arm members. The arm members terminate in hands 10. Preferably, one of the hands has a fastening means 12 such as a section of VELCRO on its surface. The fastening means allows the ends of the arm members to connect and allows the teaching aid to be placed on a person such that the teaching aid is hugging the individual. However, it is not necessary that the arm members terminate with hands, in alternative configurations the arm members may not have hands or a means of fastening the arms together. In its preferred configuration, the arm members are manufactured from a washable, wearable material.

The body also has at least one flexible leg member 14. Preferably, the teaching aid has two flexible leg members that are each comprised of a plurality of strings or fabric strands. In its preferred configuration, and as depicted in FIG. 1, the leg members have terminal ends with shoes 16 permanently attached to them. The shoes have laces 18, which may be tied by the user. Alternatively, the leg members may terminate without shoes, may be equipped with removable shoes, or may contain shoes that do not have laces. In its preferred configuration, the leg members are manufactured from a washable, wearable material.

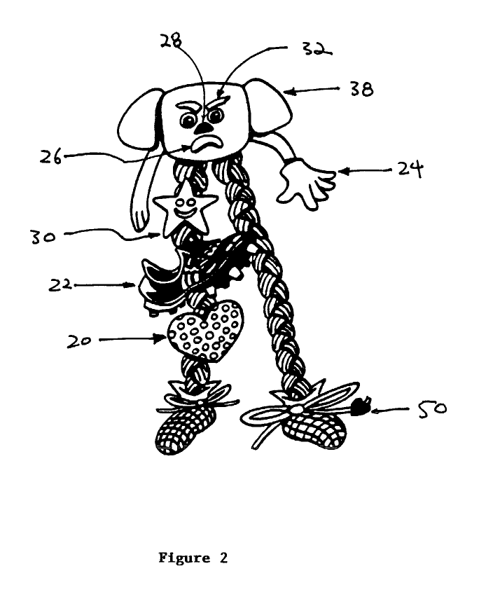

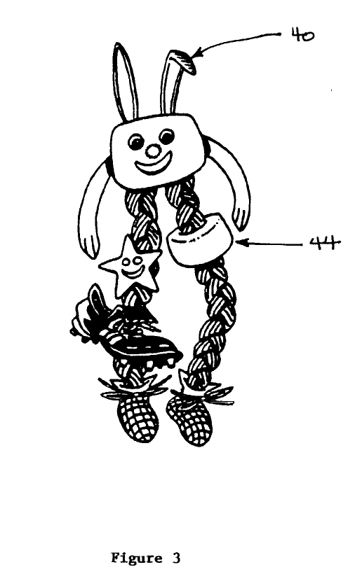

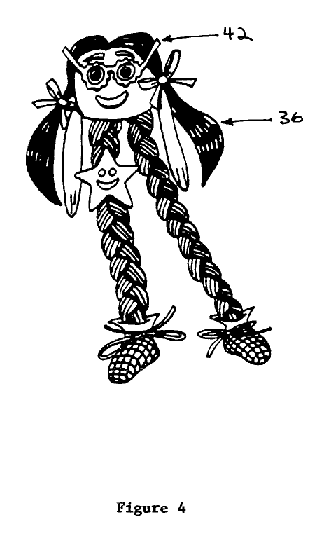

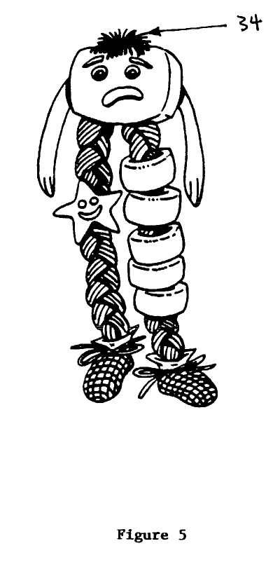

The indicia as shown in FIGS. 2 through 5 consist of a large heart 20, a shoe 22, a hand 24, a mouth 26, a nose 28, a star 30, eyebrows 32, short hair 34, long hair 36, dog ears 38, rabbit ears 40, eyeglasses 42, a small heart 50, and a plurality of annular rings 44 with openings in the middle such that a leg member may be placed through the opening attaching the annular ring to the leg member. The indicia may be manufactured from a wide variety of washable materials such as a natural or synthetic fabric or a soft plastic. In its preferred configuration, the invention has five annular ring indicia.

The indicia all have attachment means so that they may be attached to either the body, leg or arm members of the invention. With the exception of the annular rings, which are attached to the leg members through an opening on their surface, the indicia are equipped with VELCRO. VELCRO allows the indicia to be removably attached to the body, arm, and leg members of the invention.

Preferably, the mouth, nose, short hair, long hair, eyebrows, eyeglasses, dog ears, and rabbit ears are used to create the identity of the character which is the subject of the story or narrative. These are the character indicia. As depicted in FIGS. 2 through 5, the invention may be configured as a boy, a girl, a dog, or a rabbit. Other characters are possible and combining the above indicia may create novel characters. In other embodiments, different character indicia may be used.

In its preferred embodiment, the star indicia represents the setting of the story or narrative, the shoe indicia represents and initiating event or the kick-off of the story, the large heart indicia represents the feelings the character has in response to the initiating event, the hand indicia represents the plan, the annular rings represent the sequence of actions that comprise the plan, the tying of the laces of the shoes represents the direct consequences of the story, and finally the small heart indicia represents how the character feels about the direct consequence. Alternatively, different indicia with different connotations may be used.

When using the present invention, the initiating event (the shoe 16), the internal response (the large heart 20), and the plan (the hand 24) form the critical thinking triangle. The critical thinking triangle highlights the relationship among the initiating event, the internal response and the plan to answer the “why” and “how” questions that are important to understanding a story. For example, “Why is the character doing this?” and “How should the character resolve this problem?”

The invention may be used by a person as a prompt and reminder of the elements of a story and their sequence when writing or recounting a story that the person has heard or read. Typically a person would read a story and either point to the indicia already present on the invention or have the listener place the indicia on the invention in response to the readers queries. Typically, the reader would begin at the top of the teaching aid and point his/her finger at the body member and ask the question “Who is the story about?” The listener would then identify the character. At this step the listener might place the character indicia on the inventive teaching aid to create the character. Second, the person would point to the star 30 or have the listener place the star on the invention and ask the question “Where does the story take place?” Third, the person would point to the shoe 16 and ask the question “What happened to the character to cause him or her to do something?” Fourth, the person would point to the heart 20 and ask the question “What are the characters feelings about what happened?” Fifth, the person would point to the hand and ask the question “What does the character want to do?” Sixth, the reader would move or point to the first annular ring 44 and ask the question “How does the character try to solve the problem?” Seventh, the reader points to the laces of the shoe 18 and asks the question “What happens as a result of the character's action?” Eighth, the reader points to the small heart 50 and asks the question “How does the character feel about the consequence?”

In addition, the teacher may remove the indicia from the teaching aid and distribute them to students in the class and ask them to discuss some portion or aspect of the story that is represented by the symbol or indicator they are holding. Upon correctly relating the portion of the story that was assigned to that student, that person would then place the symbol in the appropriate location on the teaching aid.

The teaching aid also provides a teacher with a visual means to evaluate a student's level of discourse skills. An individual's discourse skill is reflected by that person's ability to develop stories that incorporate each element of the learning teaching aid. As a person's ability improves, he or she will progressively use or describe each element of the learning teaching aid. For instance, a pre-schooler may tell a story which simply describes the character and setting, while an early elementary student may tell a story which describes the character, the setting, the initialing event, the character's internal response, and the consequence of the internal response. By using the learning teaching aid to identify a student's deficiencies of discourse skill, a teacher may take the appropriate steps to improve that person's discourse skill.

Although the invention has been shown and described with respect to its preferred embodiment, those skilled in the art should understand that the foregoing and various other changes, omissions, and additions in the form and detail may be made without departing from the spirit and scope of the invention.

What is claimed is:

1. A teaching aid comprised of:
A body member;
At least one arm member;
At least one leg member;
A plurality of indicia that may be removably attached to said body, arm, and leg members; said indicia being removably attached to said body, arm, and leg members through indicia fastening means.

2. The teaching aid of claim 1 in which said body member is flexible

3. The teaching aid of claim 1 in which said body member is manufactured from a washable material such as a natural or synthetic fabric or a soft plastic.

4. The teaching aid of claim 1 in which said body member contains an opening that allows a user to insert their hand into the body member.

5. The teaching aid of claim 1 in which said body member contains a body member fastening means that allows the teaching aid to be removably attached to a surface or object.

6. The teaching aid of claim 5 in which said body member fastening means is a loop of material such as a natural or synthetic fabric or flexible plastic.

7. The teaching aid of claim 1 in which said body member contains at least one eye.

8. The teaching aid of claim 1 in which said arm and leg members are flexible.

9. The teaching aid of claim 1 in which said arm and leg members are manufactured from a washable material such as a natural or synthetic fabric or a soft plastic.

10. The teaching aid of claim 1 in which said arm members terminate with hands.

11. The teaching aid of claim 1 in which one of the said arm members contains an arm fastening means which allows the arm member to be attached to the other arm member or to the body member or other surface of the teaching aid.

12. The teaching aid of claim 11 in which the said arm fastening means is a VELCRO patch that is located on the surface of one of the said hands.

13. The teaching aid of claim 1 in which said leg members are comprised of a plurality of strands of material such as a synthetic or natural fabric that are braided.

14. The teaching aid of claim 1 in which said leg members terminate in a shoe with laces that may be tied.

15. The teaching aid of claim 1 in which said indicia include at least one shoe, nose, mouth, heart, star, glove, eyeglasses, pair of dog ears, pair of rabbit ears, eyebrow, long hair, short hair, hand, and annular ring.

16. The teaching aid of claim 1 in which said indicia fastening means is a VELCRO patch and is located on the surface of said indicia.

17. The teaching aid of claim 7 in which said indicia are flexible and are manufactured from a washable material such as a natural or synthetic fabric or a soft plastic.

18. A teaching aid comprised of:
A body member;
At least one arm member;
At least one leg member;
A plurality of indicia that may be removably attached to said body, arm and leg members.
said body member is flexible and is manufactured from a washable material such as a natural or synthetic fabric or a soft plastic, said body member contains an opening that allows a user to insert their hand into the body member, said body member contains at least one eye.
said arm and leg members are flexible and are manufactured from a washable material such as a natural or synthetic fabric or a soft plastic, said arm members having hands, said leg members are comprised of a plurality of strands of material that are braided.

19. The teaching aid of claim 18 in which said body member contains a body member fastening means that allows the teaching aid to be removably attached to a surface or object.

20. The teaching aid of claim 18 in which said body member fastening means is a loop of material such as a natural or synthetic fabric or flexible plastic.

21. The teaching aid of claim 18 in which one of the said arm members contains an arm fastening means which allows the arm member to be attached to the other arm member or to the body member or other surface of the teaching aid.

22. The teaching aid of claim 19 in which the said arm fastening means is a VELCRO patch that is located on the surface of said hand.

23. The teaching aid of claim 18 in which said leg members terminate in a shoe with laces that may be tied.

24. The teaching aid of claim 18 in which said indicia include at least one shoe, nose, mouth, heart, star, glove, eyeglasses, pair of dog ears, pair of rabbit ears, eyebrow, long hair, short hair, hand, and annular ring.

25. The teaching aid of claim 18 in which said indicia fastening means is a VELCRO patch and is located on the surface of said indicia.

26. The teaching aid of claim 18 in which said indicia are flexible and are manufactured from a washable material such as a natural or synthetic fabric or a soft plastic.

27. A teaching aid comprised of:
A body member;
Two arm members;
Two leg members;
A plurality of indicia that may be removably attached to said body, arm and leg members;
said body member is flexible and manufactured from a washable material such as a natural or synthetic fabric or a soft plastic, said body member having an opening that allows a user to insert their hand into the body member, said body member having a body member fastening means that allows the teaching aid to be removably attached to a surface or object, said body member fastening means is a loop of material such as a natural or synthetic fabric or flexible plastic, said body member also having two eyes attached to its surface.
said arm and leg members are flexible and are manufactured from a washable material such as a natural or synthetic fabric or a soft plastic, said arm members terminate with hands, one of the said arm members having an arm fastening means which allows the arm member to be attached to the other arm member or to the body member or other surface of the teaching aid, said arm fastening means is a VELCRO patch that is located on the surface of one of the said hands, said leg members having a plurality of strands of material that are braided, said leg members terminate in a shoe with shoe laces that may be tied.
the indicia include at least one shoe, nose, mouth, heart, star, glove, eyeglasses, pair of dog ears, pair of rabbit ears, eyebrow, long hair, short hair, hand, and five annular rings, said indicia have indicia fastening means which is a VELCRO patch and is located on the surface of said indicia, said indicia are flexible and are manufactured from a washable material such as a natural or synthetic fabric or a soft plastic.
